(19) United States
(12) Patent Application Publication
(10) Pub. No.: US 2023/0067099 A1
(43) Pub. Date: Mar. 2, 2023

(54) METHOD AND SERVER FOR PERFORMING GAME BATTLE IN LIVE BROADCAST ROOM, AND STORAGE MEDIUM

(71) Applicant: BEIJING DAJIA INTERNET INFORMATION TECHNOLOGY CO., LTD., Beijing (CN)

(72) Inventor: Xiao TANG, Beijing (CN)

(21) Appl. No.: 18/049,817

(22) Filed: Oct. 26, 2022

Related U.S. Application Data
(63) Continuation of application No. PCT/CN2020/129809, filed on Nov. 18, 2020.

(30) Foreign Application Priority Data
Jun. 22, 2020 (CN) 202010575605.9

(51) Int. Cl. A63F 13/86; H04L 65/403; H04L 67/131; A63F 13/35

(52) U.S. Cl. CPC A63F 13/86; H04L 65/403; H04L 67/131; A63F 13/35

(57) ABSTRACT

The present disclosure relates to a method and server for performing a game battle in a live broadcast room, and a non-transitory computer-readable storage medium. The following solution is disclosed: receiving a game battle request from a first client; determining a second client which performs a game battle with the first client, where at least one of the first client and the second client is an anchor client; creating a game battle according to the first client and the second client; and when an end condition of the game battle is satisfied, determining a winner according to a game battle parameter.

### CROSS REFERENCE

The present disclosure is Continuation Application of International Application No. PCT/CN2020/129809, filed on Nov. 18, 2020, which claims priority to Chinese Patent Application No. 202010575605.9 entitled “Game Battle Method and Apparatus in Live Broadcast Room”, filed on Jun. 22, 2020, and the entire contents of which are incorporated herein by reference.

### TECHNICAL FIELD

The present disclosure relates to the technical field of computers, and in particular, to a method, an apparatus, and a server for performing a game battle in a live broadcast room, and a non-transitory computer-readable storage medium.

### BACKGROUND

With the emergence of mobile live broadcast services, more and more (anchors) users start using an application program (APP) for live broadcast. Currently, the demand for the live broadcast by the (audience) user is not limited to watching in the live broadcast, and it is also desirable to obtain more pleasure from the live broadcast, thereby achieving the goal of pleasure.

### SUMMARY

The present disclosure provides a method and an apparatus for performing a game battle in a live broadcast room. The technical solutions of the present disclosure are as follows.

According to an aspect of the embodiments of the present disclosure, there is provided a method for performing a game battle in a live broadcast room, including:

receiving a game battle request from a first client;

determining a second client that is to perform the game battle with the first client, wherein at least one of the first client and the second client is an anchor client;

creating the game battle according to the first client and the second client; and

determining a winner according to a game battle parameter in response to determining that an end condition of the game battle is satisfied.

According to an aspect of the embodiments of the present disclosure, there is provided a server for performing a game battle in a live broadcast room, comprising:

a processor; and

a memory configured to store an executable instruction by the processor;

where the processor is configured to execute the instruction to implement the method for performing the game battle in the live broadcast room according to the first aspect.

According to an aspect of the embodiments of the present disclosure, there is provided a non-transitory computer-readable storage medium, where, when an instruction in the storage medium is executed by a processor of a device/server for performing a game battle in a live broadcast room, the device/server for performing the game battle in the live broadcast room is able to implement the method for performing the game battle in the live broadcast room according to the first aspect.

It is to be understood that both the foregoing general description and the following detailed description are exemplary and explanatory and do not limit the present disclosure.

### BRIEF DESCRIPTION OF THE DRAWINGS

The accompanying drawings, which are incorporated in and constitute a part of the description, illustrate embodiments consistent with the present disclosure, serve to explain the principles of the present disclosure together with the description, and do not constitute improper limits to the present disclosure.

FIG. 1 is a flowchart of a method for performing a game battle in a live broadcast room according to an embodiment.

FIG. 2 is a schematic diagram of a client interface according to an embodiment.

FIG. 3 is a block diagram of an apparatus for performing a game battle in a live broadcast room according to an embodiment.

FIG. 4 is a block diagram of a device for performing a game battle in a live broadcast room according to an embodiment.

### DETAILED DESCRIPTION

In order to make those of ordinary skill in the art better understand the technical solutions of the present disclosure, the technical solutions in the embodiments of the present disclosure will be clearly and completely described below with reference to the accompanying drawings.

It should be noted that the terms “first”, “second” and the like in the description, claims, and drawings of the present disclosure are used to distinguish similar objects, and are not necessarily used to describe a specific order or sequence. It should be understood that the data used in this way can be interchanged under appropriate circumstances, so that the embodiments of the present disclosure described herein can be implemented in an order other than those illustrated or described herein. The implementations set forth in the following description of embodiments do not represent all implementations consistent with the present disclosure. Instead, they are merely embodiments of apparatuses and methods consistent with aspects related to the present disclosure as recited in the appended claims.

The relevant information of user accounts (including social relationship identity information and the like) described in the embodiments of the disclosure are obtained under user permission. On the premise of obtaining user permission and authorization, the method, apparatus, device and storage medium involved in the disclosure can obtain the relevant information of users.

In the related art, the interaction mode between the anchor and the anchor and between the anchor and the audience in the live broadcast is limited, for example, a text message, a gift, a voice video microphone, and the like. Although the above interaction mode can meet the viewing requirement of the user to a certain extent, the viewing pleasure of the audience user cannot be effectively improved, and it seems to be dull and lacks of creativity after a long time.

In view of this, there is a need to provide a solution related to the live broadcast service, so as to improve the stickiness and activeness of the user.

FIG. 1 is a flowchart of a method 100 for a game battle in a live broadcast room according to an embodiment. As shown in FIG. 1, the method 100 for the game battle in the live broadcast room may be used in a server, and includes the following steps.

In S102, the server receives a game battle request from a first client.

In some embodiments, the first client may be an anchor client, or may be an audience client corresponding to a certain anchor client.

In some embodiments, a game invitation button is displayed in a client interface of the first client, and after the first user of the first client selects the game, the game invitation button may be clicked to generate a game battle request. Correspondingly, the server may receive the game battle request.

The game battle request may include an identifier (for example, a user identifier) of the first client, a game identifier, and the like. In some embodiments, the game battle request may include an identifier of the second client. In some embodiments, the identifier of the second client may be input by the first user, and the first user expects to perform a game battle with the second user of the second client.

In S104, the server determines a second client that is to perform the game battle with the first client, and at least one of the first client and the second client is an anchor client.

As described above, in some embodiments, the game battle request includes the identifier of the second client. Therefore, in the step the second client may be found directly based on the identifier of the second client, and the game invitation information may be sent to the second client, where the game invitation information may include an identifier (for example, a user identifier) of the first client, a game identifier, and the like.

In some embodiments, before S106, a response information of the second client may be further received by the server, where the response information indicates that the second user of the second client agrees to perform a game battle with the first client (the first user).

In some embodiments, the server may further determine the second client that is to perform the game battle with the first client in a random matching manner. According to the embodiments, the first user of the first client does not need to select the opponent of the game battle, it can be realized in a random matching manner, so that it is convenient to improve the game interestingness of the user and increase the viscosity of the user.

In S106, the server creates the game battle according to the first client and the second client.

In this step, the game battle may be created according to the game roles of the first client and the second client, the game level, the selected game scene, etc.

In this way, the first client and the second client may perform the game battle, and in a process of the game battle between the first client and the second client, the server may further obtain a video screen of the game battle, and provide the video picture to the audience client for viewing.

In some embodiments, the first client and the second client are both anchor clients, and the audience client mentioned above may include an audience client corresponding to the first client and an audience client corresponding to the second client. The audience client corresponding to the first client mentioned above, that is, the user of the audience client, can view the live content broadcast by the user of the first client.

In some embodiments, the first client is an anchor client, the second client is an audience client corresponding to the first client, and the v audience client mentioned above may include a plurality of audience clients corresponding to the first client.

In some embodiments, in some embodiments, before S108, the server may further receive request information for applying a battle, where the request information may be sent by the audience client and is used to request to perform the game battle replacing the corresponding anchor client (for example, the first client). In this way, the method 100 for the game battle in the live broadcast room may further include the following steps: replacing the first client with the audience client sending the request information for performing the game battle based on the request information. In some embodiments, the audience user may apply to replace his own anchor for performing the game battle, which improves the interestingness of the game battle and improve the user experience.

In S108, in response to determining that an end condition of the game battle is satisfied, the server determines the winner according to a game battle parameter.

The end condition of the game battle may be that, for example, a total duration of the game battle reaches a preset duration; the blood volume consumption of one party of the game battle is completed; and a party of the game battle sends request information requesting to exit the game battle, etc.

The above-mentioned game battle parameter includes, for example, under a three-office two-win game rule, the number of wins and losses of the two parties, etc.

In some embodiments, in some embodiments, after the winner is determined, the anchor avatar corresponding to the winner may be highlighted. In some embodiments, the first client and the second client may both be anchor clients, that is, the first user using the first client is an anchor user, and the second user using the second client is also an anchor user. In some embodiments, while the first client and the second client perform the game battle, the server may further obtain the video screen of the game battle and provide it to the audience client. The audience client includes an audience client corresponding to the first client and an audience client corresponding to the second client. In this way, after the winner is determined, the anchor avatar corresponding to the winner may also be highlighted in the audience client to enhance the sense of honor of the audience of the winner.

In some embodiments, while displaying the video screen of the game battle in the audience client, real-time video images of both battle parties may be displayed at the same time, and the video images include a face image of the anchor (that is, an anchor avatar). In some embodiments, the mentioned highlighting the anchor avatar corresponding to the winner may include, for example, detecting the face avatar of the anchor in the real-time video images, and adding a pendant such as a crown of victory on the avatar of the anchor after the avatar of the anchor is detected, so that the interestingness is enhanced, and the user experience is improved.

The method for performing the game battle in the live broadcast room provided by the present disclosure supports game battle between the anchor client and the anchor client, or between the anchor client and the audience client, which organically combines both the live broadcast and the game, effectively improves the viewing pleasure of the audience user, facilitates improving the stickiness and activity of the user, and improves the user experience.

When the method 100 for the game battle in the live broadcast room is introduced, the first client and the second client that is to perform the game battle (i.e., 1 V 1 battle) are taken as an example for illustration. In practice, the game battle may also be a many-to-many group game. In this way, before the determining the winner according to the game battle parameter in response to determining that the end condition of the game battle is satisfied in the method 100 for the game battle in the live broadcast room, the method further includes at least one of the following:

1) receiving first invitation information from the first client, where the first invitation information is used to invite at least one third client to join the first battle team;

2) receiving second invitation information from the second client, where the second invitation information is used to invite at least one fourth client to join the second battle team.

In some embodiments, the first client may belong to the first battle team, the second client may belong to the second battle team, and both the first client and the second client may be the anchor client.

In some embodiments, the first client may send the first invitation information for inviting at least one audience client (i.e., a third client) corresponding to the first client to join the first battle team; and the second client may also send second invitation information for inviting at least one audience client (i.e., the fourth client) corresponding to the second client but join the second battle team.

According to some embodiments, more users can be accommodated to participate in the game battle at the same time, which further facilitates to improve the viewing pleasure of the audience users, improve the stickiness and activeness of the users, and improve the user experience.

In some embodiments, during introduction, it is taken as an example that the first client sends the first invitation information, and the second client also sends the second invitation information as an example for description. In practice, it may also be realized by the way that an audience client actively signs up to participate in the battle. In this way, at least one of the first client and the second client may not send the invitation information. In some embodiments, different implementations of the multi-person joining the game are provided for the anchor client and the audience client to select, thereby improving the user experience.

In some embodiments, before creating the game battle according to the first client and the second client, the method further includes: establishing an audio and video connection for the first client and the second client, where a game selection page is displayed on the first client and the second client; and determining a selected game battle based on a negotiation result of the first client and the second client.

In some embodiments, both the first client and the second client are anchor clients, and said determining the second client that is to perform the game battle with the first client mentioned in the method 100 for the game battle in the live broadcast room includes: determining, in a random matching manner, the second client that is to perform the game battle with the first client.

In some embodiments, both the first client and the second client are anchor clients, and said determining the second client that is to perform the game battle with the first client mentioned in the method 100 for the game battle in the live broadcast room includes: determining, based on the game battle request, the second client that is to perform the game battle with the first client, where the game battle request includes invitation information used to invite the second client.

In some embodiments, both the first client and the second client are anchor clients, and said determining the second client that is to perform the game battle with the first client mentioned in the method 100 for the game battle in the live broadcast room includes: determining the second client that is to perform the game battle with the first client based on at least one of followings of the first client:

1) a historical record;

2) geographical location information; and

3) a live broadcast type, where the first client is an anchor client.

In some embodiments, for example, the server may select a second client matching the historical record of the first client. The historical record may include, for example, a winning rate, a total number of fields (or times) of the game battle, and the like. The above-mentioned matching the historical record, for example, may be that the winning rate is approaching, the total number of fields is approaching, etc.

For another example, the server may select the second client closest to the geographic location of the first client, select the second client farthest from the geographic location of the first client, and the like. In some embodiments, the game battle request sent by the first client may carry the geographical location information of the first client. Correspondingly, the server may also obtain the geographical location information of the second client, for example, the second client may have sent the game battle request to the server as the first client, and the game battle request from the second client carries the geographical location information of the second client. In some embodiments, the server may further determine the geographical location information of each client based on the IP address of each client, and each client mentioned here includes the first client and the second client.

For another example, the server may select the second client matching the live broadcast type of the first client, and the live broadcast type may include, for example, a game live broadcast type, a food live broadcast type, a tourism live broadcast type, and the like. The above-mentioned matching the live broadcast type, for example, may be that the live broadcast type is the same, etc.

It should be noted that the server may further combine two or three of: the historical record, the geographical location information, and the live broadcast type, to select the second client. For example, the server selects the second client that matches the historical record of the first client and matches the live broadcast type of the first client; for another example, the server selects the second client that matches the historical record of the first client, has a distance within a preset range from first client, matches the live broadcast type of the first client, and the like, which is not specifically limited in these embodiments.

In some embodiments, the first client is an anchor client, the second client is an audience client corresponding to the anchor client, and said determining the second client that is to perform the game battle with the first client mentioned in the method 100 for the game battle in the live broadcast room includes: determining, based on the game battle request, the second client performing the game battle with the first client, where the game battle request includes invitation information for inviting the second client.

As mentioned above, when the first client and the second client perform the game battle, the server also obtain the video screen of the game battle and provides it to the audience client, and the audience client includes an audience client corresponding to the first client and an audience client corresponding to the second client. In some embodiments, before said determining the winner according to the game battle parameter in response to determining that the end condition of the game battle is satisfied mentioned in the method 100 for the game battle in the live broadcast room, the method further includes:

receiving audio and video information, where the audio and video information includes: first video information and first audio information of the first client, and second video information and second audio information of the second client;

merging the first video information and the second video information, and merging the first audio information and the second audio information; and

sending the merged video information and audio information to an audience client, so that the audience client plays the merged video information and audio information; where the audience client corresponds to at least one of the first client and the second client.

In some embodiments, the first audio information and the second audio information may be obtained by using a sound collection device, and the sound collection device may be a microphone, or may be an earpiece.

In some embodiments, the first audio information and the second audio information may be obtained by using the sound collection device, and the first audio information and the second audio information may be synthesized into an audio mixed stream. For example, when it is detected that the game battle starts, the microphone and the camera will be connected. The anchor avatar video image is collected through the camera of the live broadcast room corresponding to the at least two battle parties, the audio stream is collected through the microphone of the live broadcast room corresponding to the at least two battle parties, and the audio stream collected through the microphones of the live broadcast room corresponding to the at least two battle parties is synthesized into an audio mixed stream.

In some embodiments, the first client and the second client are both anchor clients, where the first video information includes a game video image of the first client and an anchor avatar corresponding to the first client, and the second video information includes a game video image of the second client and an anchor avatar corresponding to the second client.

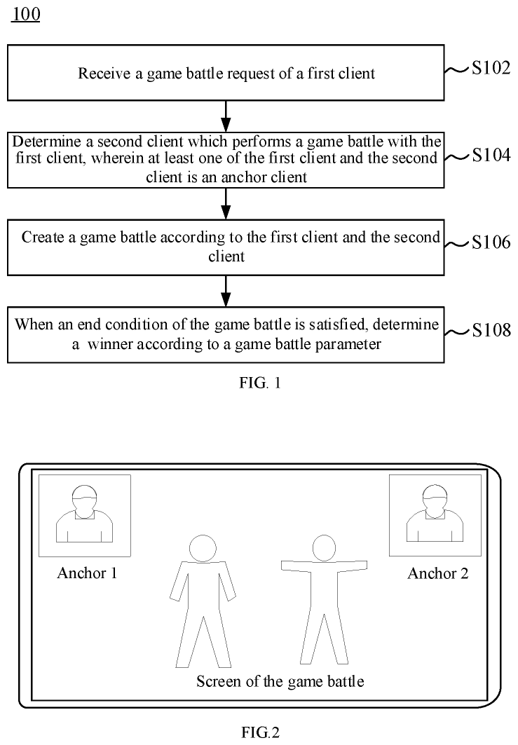

In some embodiments, as shown in FIG. 2, the client interface of the audience client is shown in FIG. 2. The game battle video (picture) between the first client and the second client is displayed in the client interface, and the anchor avatar corresponding to the first client (seeing anchor 1 in FIG. 2) and the anchor avatar corresponding to the second client are also displayed (seeing anchor 2 in FIG. 2).

In some embodiments, the game video image and the anchor head video image of the at least two battle parties are pushed into the audience client viewing the live broadcast room, and the audio mixed stream is played synchronously.

In some embodiments, in some embodiments, the anchor avatar may be a real-time video avatar of the anchor user, so that the user can also see the real-time state of the anchor while viewing the game battle, thereby improving the user experience.

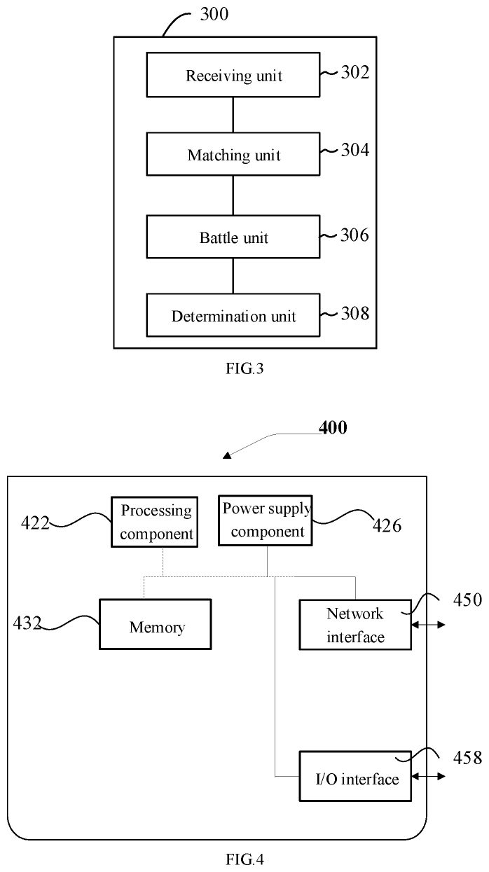

FIG. 3 is a block diagram of an apparatus for performing a game battle in a live broadcast room according to an embodiment. Referring to FIG. 3, the apparatus includes a receiving unit 302, a matching unit 304, a battle unit 306, and a determination unit 308

The receiving unit 302 is configured to perform receiving a game battle request from a first client.

The matching unit 304 is configured to perform determining a second client that is to perform the game battle with the first client, wherein at least one of the first client and the second client is an anchor client.

The battle unit 306 is configured to perform creating the game battle according to the first client and the second client.

The determination unit 308 is configured to perform determining a winner according to a game battle parameter in response to determining that an end condition of the game battle is satisfied.

The apparatus for performing the game battle in the live broadcast room provided by the present disclosure supports game battle between the anchor client and the anchor client, or between the anchor client and the audience client, which organically combines both live broadcast and game, effectively improves the viewing pleasure of the audience user, facilitates improving the stickiness and activity of the user, and improves the user experience.

Further, in some embodiments, the first client belongs to a first battle team, the second client belongs to a second battle team, and the receiving unit 302 may be further configured to perform at least one of the following:

receiving first invitation information from the first client, wherein the first invitation information is used to invite at least one third client to join the first battle team;

receiving second invitation information from the second client, wherein the second invitation information is used to invite at least one fourth client to join the second battle team.

Further, in some embodiments, the apparatus further includes: a communication unit configured to perform establishing an audio and video connection for the first client and the second client, where a game selection page is displayed on the first client and the second client; where the determination unit is configured to perform determining a selected game battle based on a negotiation result of the first client and the second client.

Further, in some embodiments, both the first client and the second client are anchor clients, and the matching unit 304 is configured to perform:

determining the second client that is to perform the game battle with the first client in a random matching manner; or

determining the second client that is to perform the game battle with the first client based on the game battle request, wherein the game battle request comprises invitation information used to invite the second client; or

determining the second client that is to perform the game battle with the first client based on at least one of followings of the first client: a historical record geographic location information, and a live broadcast type.

Further, in some embodiments, the first client is an anchor client, the second client is an audience client corresponding to the anchor client, and the matching unit 304 is configured to perform determining the second client that is to perform the game battle with the first client based on the game battle request, wherein the game battle request comprises invitation information used to invite the second client.

Further, in some embodiments, the receiving unit 302 may be further configured to perform:

receiving audio and video information, where the audio and video information includes: first video information and first audio information of the first client, and second video information and second audio information of the second client;

merging the first video information and the second video information, and merging the first audio information and the second audio information; and

sending merged video information and audio information to an audience client, causing the audience client to play the merged video information and audio information; where the audience client corresponds to at least one of the first client and the second client.

Further, in some embodiments, the first client and the second client are both anchor clients, where the first video information includes a game video image of the first client and an anchor avatar corresponding to the first client, and the second video information includes a game video image of the second client and an anchor avatar corresponding to the second client.

Further, in some embodiments, the determination unit 308 may be further configured to perform highlighting an anchor avatar corresponding to the winner.

With regard to the apparatus in the foregoing embodiments, the specific manner in which the modules perform operations has been described in detail in the embodiments related to the method, and will not be described in detail here.

FIG. 4 is a block diagram of a device 400 for performing a game battle in a live broadcast room according to an embodiment. The device 400 for the game battle in the live broadcast room corresponds to the server mentioned in the method 100, and also corresponds to the apparatus 300 for the game battle in the live broadcast room in the embodiment shown in FIG. 3.

The device 400 may be provided as a server. Referring to FIG. 4, the device 400 includes a processing component 422 that further includes one or more processors, and memory resources represented by the memory 432 for storing instructions, such as applications, that may be executed by the processing component 422. An application stored in memory 432 may include one or more modules each corresponding to a set of instructions. Further, the processing component 422 is configured to execute instructions, so as to implement the method 100 described above.

The device 400 may also include a power supply component 426 configured to perform power management of the device 400, a wired or wireless network interface 450 configured to connect the device 400 to a network, and an input/output (I/O) interface 458. The device 400 may operate based on an operating system stored in the memory 432, such as Windows Server™, Mac OS X™, Unix™, Linux™, FreeBSD™, or the like.

In some embodiments, there is further provided a storage medium including an instruction, for example, a memory including an instruction. The instruction may be executed by a processor of a device for a game battle in a live broadcast room to complete the method for performing the game battle in the live broadcast room. In some embodiments, the storage medium may be a non-transitory computer-readable storage medium. For example, the non-transitory computer-readable storage medium may be a ROM, a random access memory (RAM), a CD-ROM, a magnetic tape, a floppy disk, an optical data storage device, etc.

It should be noted that the method for performing the game battle in the live broadcast room executed by the device 400 in these embodiments has the same or corresponding technical features as the method for performing the game battle in the live broadcast room in the foregoing embodiment. Therefore, the detailed description of the method for performing the game battle in the live broadcast room in these embodiments may refer to the description of the method for performing the game battle in the live broadcast room in the aforementioned method for performing the game battle in the live broadcast room. Details are not described here again in these embodiments.

In some embodiments, there is further provided a computer program product, including at least one non-transitory computer-readable medium storing an instruction translatable by at least one processor, for implementing the foregoing method for performing the game battle in the live broadcast room.

It should be noted that, the method for performing the game battle in the live broadcast room implemented by the computer program product in these embodiments has the same or corresponding technical feature as the method for performing the game battle in the live broadcast room in the aforementioned method for performing the game battle in the live broadcast room. Therefore, the detailed description of the method for performing the game battle in the live broadcast room in these embodiments may refer to the description of the method for performing the game battle in the live broadcast room in the aforementioned method for performing the game battle in the live broadcast room. Details are not described here again in these embodiments.

Those skilled in the art will easily think of other embodiments of the present disclosure after considering the description and practicing the present disclosure here. The present disclosure is intended to cover any variation, use or adaptive change of the present disclosure, which follows the general principles of the present disclosure and includes the common knowledge or customary technical means in the technical field not disclosed in the present disclosure. The description and the embodiments are considered as exemplary, and the true scope and spirit of the present disclosure are indicated by the following claims.

It should be understood that the present disclosure is not limited to the precise structure already described above and shown in the drawings, and various modifications and changes may be made without departing from the scope of the present disclosure. The scope of the present disclosure is limited only by the appended claims.

What is claimed is:

1. A method for performing a game battle in a live broadcast room, comprising:
determining, in response to a battle request from a first client, a second client that is to perform the game battle with the first client, wherein at least one of the first client and the second client is an anchor client;
performing the game battle according to the first client and the second client; and
obtaining a result of the game battle in response to determining that an end condition of the game battle is satisfied.

2. The method according to claim 1, wherein the first client belongs to a first battle team, the second client belongs to a second battle team, and the method further comprises at least one of:
receiving first invitation information from the first client, wherein the first invitation information is used to invite at least one third client to join the first battle team; and
receiving second invitation information from the second client, wherein the second invitation information is used to invite at least one fourth client to join the second battle team.

3. The method according to claim 2, wherein the method further comprises:
establishing an audio and video connection for the first client and the second client, wherein a selection page is displayed on the first client and the second client; and
determining a selected game battle based on a negotiation result of the first client and the second client.

4. The method according to claim 1, wherein both the first client and the second client are anchor clients, and said determining the second client that is to perform the game battle with the first client comprises:
determining the second client in a random matching manner; or
determining the second client based on the battle request, wherein the battle request comprises invitation information used to invite the second client; or
determining the second client based on at least one of followings of the first client: a historical record, geographic location information, and a live broadcast type.

5. The method according to claim 1, wherein, the first client is an anchor client, the second client is an audience client corresponding to the anchor client, and said determining the second client that is to perform the game battle with the first client comprises:
determining the second client based on the battle request, wherein the battle request comprises invitation information used to invite the second client.

6. The method according to claim 1, wherein, the method further comprises:
receiving audio and video information, wherein the audio and video information comprises: first video information and first audio information of the first client, and second video information and second audio information of the second client;
merging the first video information and the second video information, and merging the first audio information and the second audio information; and
sending merged video information and audio information to an audience client, causing the audience client to play the merged video information and audio information; wherein the audience client corresponds to at least one of the first client and the second client.

7. The method according to claim 6, wherein both the first client and the second client are anchor clients, wherein:
the first video information comprises a first video image of the first client and a first anchor avatar corresponding to the first client; and
the second video information comprises a second video image of the second client and a second anchor avatar corresponding to the second client.

8. The method according to claim 7, wherein, the method further comprises:
highlighting an anchor avatar corresponding to the result of the game battle.

9. A server for performing a game battle in a live broadcast room, comprising:
a processor; and
a memory, configured to store an instruction executable by the processor;
wherein the processor is configured to execute the instruction to implement a method for performing a game battle in a live broadcast room, comprising:
determining, in response to a battle request from a first client, a second client that is to perform the game battle with the first client, wherein at least one of the first client and the second client is an anchor client;
performing the game battle according to the first client and the second client; and
obtaining a result of the game battle in response to determining that an end condition of the game battle is satisfied.

10. The server according to claim 9, wherein the first client belongs to a first battle team, the second client belongs to a second battle team, and the method further comprises at least one of:
receiving first invitation information from the first client, wherein the first invitation information is used to invite at least one third client to join the first battle team; and
receiving second invitation information from the second client, wherein the second invitation information is used to invite at least one fourth client to join the second battle team.

11. The server according to claim 10, wherein the method further comprises:
establishing an audio and video connection for the first client and the second client, wherein a selection page is displayed on the first client and the second client; and
determining a selected game battle based on a negotiation result of the first client and the second client.

12. The server according to claim 9, wherein both the first client and the second client are anchor clients, and said determining the second client that is to perform the game battle with the first client comprises:
determining the second client in a random matching manner; or
determining the second client based on the battle request, wherein the battle request comprises invitation information used to invite the second client; or
determining the second client based on at least one of followings of the first client: a historical record, geographic location information, and a live broadcast type.

13. The server according to claim 9, wherein, the first client is an anchor client, the second client is an audience client corresponding to the anchor client, and said determining the second client that is to perform the game battle with the first client comprises:
determining the second client based on the battle request, wherein the battle request comprises invitation information used to invite the second client.

14. The server according to claim 9, wherein, the method further comprises:
receiving audio and video information, wherein the audio and video information comprises: first video information and first audio information of the first client, and second video information and second audio information of the second client;
merging the first video information and the second video information, and merging the first audio information and the second audio information; and
sending merged video information and audio information to an audience client, causing the audience client to play the merged video information and audio information; wherein the audience client corresponds to at least one of the first client and the second client.

15. The server according to claim 14, wherein both the first client and the second client are anchor clients, wherein:
the first video information comprises a first video image of the first client and a first anchor avatar corresponding to the first client; and
the second video information comprises a second video image of the second client and a second anchor avatar corresponding to the second client.

16. The server according to claim 15, wherein, the method further comprises:
highlighting an anchor avatar corresponding to the result of the game battle.

17. A non-transitory computer-readable storage medium, wherein, when an instruction in the storage medium is executed by a processor of a device for performing a game battle in a live broadcast room, the device for performing the game battle in the live broadcast room is able to implement a method for performing a game battle in a live broadcast room, comprising:
determining, in response to a battle request from a first client, a second client that is to perform the game battle with the first client, wherein at least one of the first client and the second client is an anchor client;
performing the game battle according to the first client and the second client; and
obtaining a result of the game battle in response to determining that an end condition of the game battle is satisfied.

18. The non-transitory computer-readable storage medium according to claim 17, wherein the first client belongs to a first battle team, the second client belongs to a second battle team, and the method further comprises at least one of followings:
receiving first invitation information from the first client, wherein the first invitation information is used to invite at least one third client to join the first battle team; and
receiving second invitation information from the second client, wherein the second invitation information is used to invite at least one fourth client to join the second battle team.

19. The non-transitory computer-readable storage medium according to claim 17, wherein the method further comprises:
receiving audio and video information, wherein the audio and video information comprises: first video information and first audio information of the first client, and second video information and second audio information of the second client;
merging the first video information and the second video information, and merging the first audio information and the second audio information; and
sending merged video information and audio information to an audience client, causing the audience client to play the merged video information and audio information; wherein the audience client corresponds to at least one of the first client and the second client.

20. The non-transitory computer-readable storage medium according to claim 17, wherein the method further comprises:
highlighting an anchor avatar corresponding to the result of the game battle.
